(19) United States
(12) Patent Application Publication
(10) Pub. No.: US 2015/0004586 A1
(43) Pub. Date: Jan. 1, 2015

(54) MULTI-LEVEL E-BOOK

(71) Applicant: KYLE TOMSON, SALEM, OR (US)

(72) Inventor: KYLE TOMSON, SALEM, OR (US)

(21) Appl. No.: 13/928,282

(22) Filed: Jun. 26, 2013

(51) Int. Cl. G09B 5/06

(52) U.S. Cl. CPC G09B 5/06
USPC 434/322; 434/365; 434/308

(57) ABSTRACT

The present invention teaches an interactive e-book with a coherent type of content presented in multiple formats as tailored to students of varied skill levels and needs to permit a diverse range of students to be presented with a uniform coherent body of instructional material. Further improvements include a system of regular interactive test modules to provide both comprehension feedback and to ascertain any adjustment in the content presentation as tailored to each student.

### FIELD OF INVENTION

The present invention relates generally to an electronic book or an e-book for teaching and more specifically for an e-book that contains multiple levels of reading content to relate the same underlying content in an educational environment. The present invention teaches an interactive e-book with a coherent type of content presented in multiple formats as tailored to students of varied skill levels and needs to permit a diverse range of students to be presented with a uniform coherent body of instructional material tailored to specific reading or instructional needs. Further improvements include a system of regular interactive test modules to provide both retention testing and comprehension feedback and to ascertain any adjustment in the content presentation as tailored to each student.

### BACKGROUND OF THE INVENTION

Textbooks and the presentation of uniform information sets to a student group are the staples of the modern education system. Whether in the form of the hard bound heavy book that students turn from page to page, or in the modern iterations of web pages, interactive video systems or e-books on modern tablets, the general process remains the same, namely: a coherent body of information is uniformly relayed to a student or group of students; the students are tested for comprehension and retention; with sufficient scores, student advance to the next body of information which is presented; on insufficient scores the body of information is reviewed again and then tested again.

In addition to the basic structures of group learning, often driven by economics, there is also an advantage to maintaining peer-to-peer interactions in an educational environment. Often students find the peer-to-peer dynamic of group learning to be just as important as the student-to-teacher dynamic. Learning in a group environment permits peer reinforcement and exploration of knowledge. As well there are aspects of socialized knowledge with the interaction of peers and peer-to-peer relations, exchanges and general discussions of knowledge as students learn in a group that facilitate the learning process.

With budget cutbacks and changes in teaching, class size and the size of the groups of students presented with a singular body of information have increased in numbers. With an increase in class size comes a growing diversity in skill sets and reading capacity as a single class may contain students of varying capacities. While some students may be capable of reading one level of a text, other students whether due to reading skills or even cultural or language issues, may have differing capacities to comprehend and retain content from a singular text source. As a result, an entire group is often limited in the material they are able to cover due to the capacity of a minority. The result is that teaching systems are rarely optimized to include the extremes of student capabilities and often targeted to the mean students capabilities, or even lower range of any specific group so as to maximize inclusion. Such “mainstreaming” is most evident in our general elementary education system where an average classroom will have students of varying skill sets. A 5^{th} grade classroom might have students with reading levels from the 1^{st} to the 9^{th} grade. A teacher tasked with teaching a basic science curriculum is required to present a singular coherent body of information to this diverse student body and each student is then expected to assimilate the information if not equally, at least jointly.

As a result in such a 5^{th} grade class, an informational or instructional set may be presented to the lower level students in a manner that those that are below the reading level mean are able to struggle but still assimilate information. However those at mean reading level are nominally challenged and students reading at a higher level are simply bored as the underlying content of the information set is presented at a reading level that is unable to engage the advanced student. This singular text based system, targeted to a mean or slightly below mean level of capability, results in less than optional educational experiences for students at both extreme.

Similar situations occur when students have linguistic barriers such they their ability to read and assimilate text based content may differ when exposed to differing languages and verbal skills may differ from reading skills. In such a situation a student may be fully capable of understanding and socially discussing a matter with a teacher or their peers, but may have a greater capacity to assimilate content in a distinct language which differs from the manner of content presentation required by the majority of the class. As may be the case a classroom may have native Russian, English and Spanish speakers that are all equally conversant, but in assimilating new concepts and information, presentation in their native language is preferred.

As can be seen, diversity is both a benefit in an educational environment but it can also be a detriment. Diversity is itself an educational tool, but it makes it difficult to present a large group of students with a coherent body of information. Efforts to segregate students into groups based on capability breaks down the peer-to-peer aspects of learning and impairs the communal benefits of a learning environment and the benefits that diversity my offer. Similarly segregation results in the need for more teachers, or teachers with distributed attention who are required to focus and relate to individual sub-groups, forgoing the classroom as a whole.

What is clearly needed is a means of presenting a singular coherent body of instructional information in a manner that relates to students of varying capabilities and reading levels to ensure that students are engaged in the instructional material yet permitted individualized instruction. Such a means of presenting a coherent body of instruction across a ride variety user capabilities is presented herein.

### SUMMARY OF THE INVENTION

An e-book generally includes: a display system; an interface shell and a content set. In the academic environment it is known to further include a testing matrix and a data output system to permit testing and relation of the test results. The display system may be an internal/web interface, a computer, or a tablet such as the Apple™ iPad™ commonly used for e-books. The display system general includes a means of storing and retrieving data both in the form of the content to be displayed and a means of receiving testing and testing date results for processing or review. The interface shell is the generally the user interface that is often standardized across multiple bodies of content to permit a user to learn and become with a singular interface standard for any content the display system may provide. The content set is generally the information to be displayed on the display system through the interface shell that may include text, pictures, sounds, video and interactive animations or other means of relating content and engaging a student. The testing matrix is a system of evaluating the comprehension and retention of the content by the student. Testing matrixes may be integral and presented through the interface shell, or external though other means including traditional paper and pen. The data output system is a method of collecting and presenting available data related to a student's use of the display system either by saving data to the internal storage of the display system for later retrieval or by transmission to an external system. Such data may include time spent by the student on any particular point of content, such as might indicate reading speed, interest, or comprehension. Such data might also include the result of integral testing at periodic intervals and may also include other feedback systems installed throughout the content.

Novel and useful in the instant disclosure is a method and system of providing multiple content sets, each with a largely coherent and uniform information set, but each targeting a differing target student's capabilities. The provided system permits uniform information content, such as instructional information on forest ecology, but in multiple content sub-sets such that one content sub-set may be targeted to a 3^{rd} grade reading level, one to a 5^{th} grade reading level, and a third to a 7^{th} grade reading level. It is also possible in have a content sub-set in Spanish or another language such that students may at any time switch between reading levels or even languages to provide student specific and targeted content yet maintain a uniform information set such that a larger group of students tray be instructed in specific coherent information comprising a uniform set of content. Content may also be presented in supporting audio format for audio playback of the text presented in either the language of the text, or an in a complementing language of the student such that a student may be permitting to read an English text, yet have either a chapter, paragraph, sentence, or even simply a word read back in an alternate language for improved comprehension.

Further benefit is provided in the presentation of a testing matrix that provides testing for both content retention or learning and comprehension of the presented material, namely whether the level of material presented is proper, above, or below the optimal level and form for the specific student.

### BRIEF DESCRIPTION OF THE DRAWINGS

The above description and other objects, advantages, and features of the present embodiment will be more fully understood and appreciated by reference to the specification and accompanying drawings, wherein:

FIG. 1 is a depiction of a form of initial opening screen with features.

FIG. 2 is a depiction of a form of level 1 content presentation with level selection.

FIG. 3 is a depiction of a form of level 2 content presentation.

FIG. 4 is a depiction of a form of level 3 content presentation.

FIG. 5 is a depiction of a form of level 4 content presentation.

FIG. 6 is a depiction of a form of level 5 content presentation.

FIG. 7 is an alternate depiction of a form of level 1 content presentation.

FIG. 8 is an alternate depiction of a form of level 2 content presentation.

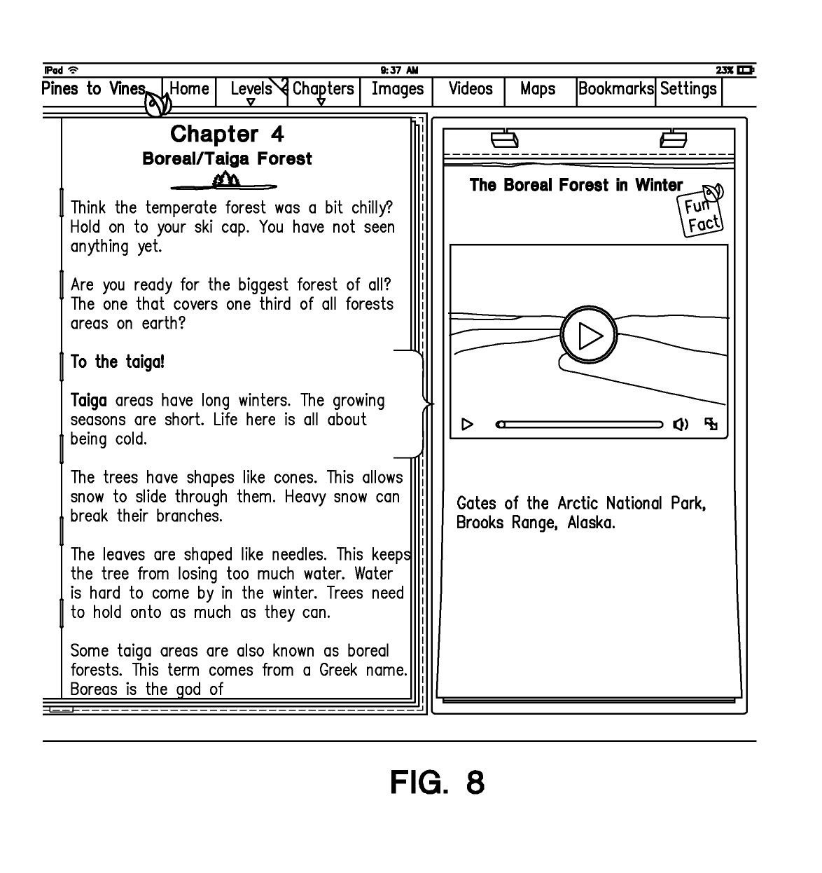

FIG. 9 is an alternate depiction of a form of level 3 content presentation.

FIG. 10 is an alternate depiction of a form of level 4 content presentation.

FIG. 11 is an alternate depiction of a form of level 5 content presentation.

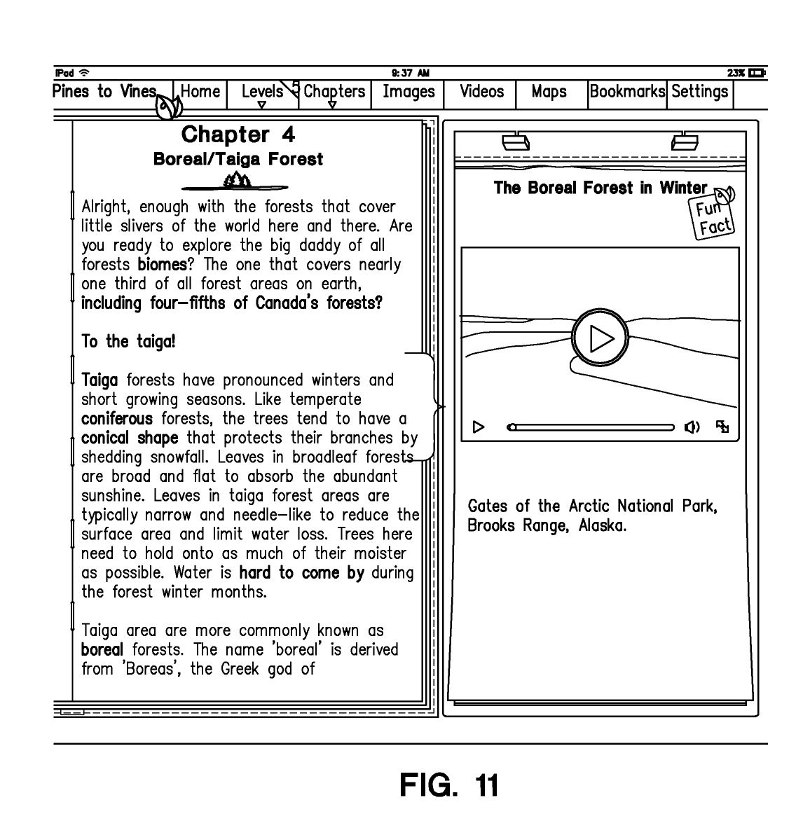

FIG. 12 is a depiction of a form of level 3 content presentation with dynamic graphical/image display.

FIG. 13 is a depiction of a form of level 3 content presentation with inline hypertext.

FIG. 14 is a depiction of a form of level 3 content presentation with related video content.

FIG. 15 is a depiction of a form of level 3 content presentation with inline dynamic map presentation.

FIG. 16 is a depiction of a form of initial test registration.

FIG. 17 is an outline of component relation for the invention.

### DETAILED DISCUSSION OF THE PREFERRED EMBODIMENTS

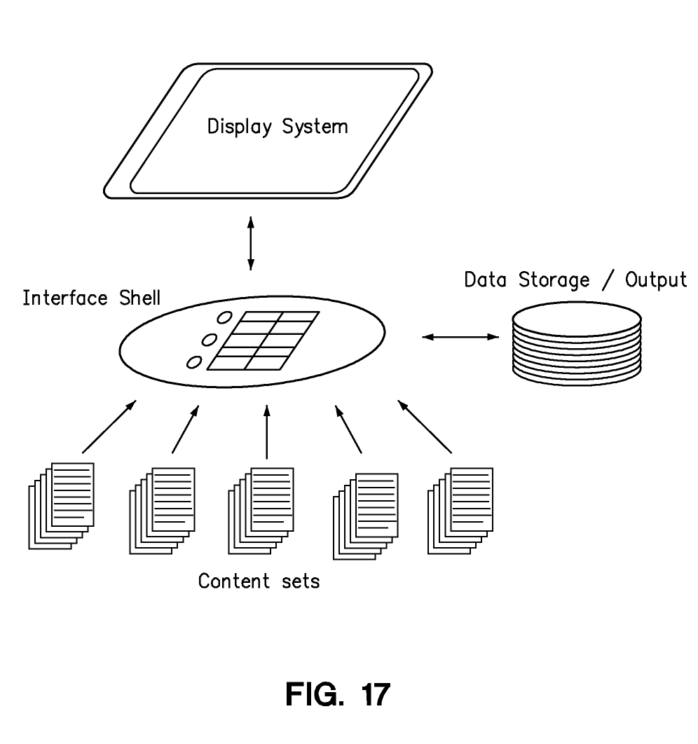

The preferred embodiment the invention comprises a display system, interface shell, and content which comprises multiple interchangeable content sub-sets that are coherently interchangeable, and a method of selecting between the interchangeable content sub-sets. The function of the invention is to permit content to be displayed to readers or observers of varying capabilities, and to permit the display system, through use of the interface shell, to dynamically interchange between content sub-sets to permit a coherent but differing presentation of a largely singular set of the same information to varying parties. The general overview of the invention may be seen depicted in FIG. 17.

In the preferred embodiment, the invention may be used in an educational environment wherein students have differing capacities or reading levels and allow a singular teacher to present the same set of information coherently to multiple students. One student may review a textual and graphical presentation tailored to their reading level with another student receiving the same essential information at a different reading level. Each student may then review the same core facts and perceive the same or similar correlating images, videos or graphics, but with each student viewing content tailored to their learning abilities. This permits the students to study the same coherent information side by side, yet each to view information appropriate to their reading level, vocabulary or language skills. The invention similarly permits a single teacher to review the same information received by each student and for the students to interact with the teacher and each other with the same information.

In an alternate embodiment the same coherent sub-sets of content might comprise multiple languages and such languages at multiple levels such that students may be able to review content in one language and switch between languages as needed to study the material or even to study the language. Such may be useful in learning a language, or in studying concepts that evade direct or easy translation by permitting a user to review information in a primary source language and then review one of more translations that maybe be over-laid or coherently exchanged. The invention also permits the same essential information to be presented in varying degrees of complexity, such that in the study of complex concepts which rely on integrated premises, concepts may be presented in an overlay method of varying degrees of sub-textual integration or explanation.

The display system generally includes a means of storing and retrieving data both in the form of the content to be displayed and a means of receiving testing and testing date results for processing or review, though testing may be extrinsic and even by traditional pen and paper.

In a preferred embodiment the display system comprises an Apple™ iPad™, though any tablet, or eve any internet or web based interface will suffice with nominal adjustment. The functionality of the display system is to manage the interface shell and content, including content sub-sets and permit the display of content, and preferably the collection of testing data obtained though use of the testing matrix. And while the display system is preferably based on a portable touch screen, a conventional screen and keyboard or other input means may suffice.

The interface shell may be integrated to display system and a part of the operating system of the display system or the interface shell may be a secondary application which interfaces with the content and the display system and manages the user interaction and display of content. The interface shell is generally the user interface that is often standardized across multiple bodies of content to permit a user to learn and become familiar with a singular interface standard for any content the display system may provide.

The interface shell is also the preferred means for the user to select which content subset is to be displayed and the means to integrate the content sub-sets with other information such that altering texts may be displayed or presented with coherent images or video for a unified coherent presentation of information regardless of the content sub-set presented.

In the preferred embodiment the interface shell is the vehicle the users use to load the selected content and content sub-set and interact with the content presented. The interface shell is also the vehicle for managing data in and out related to the users experience and any testing, such that the interface shell may manage time spent on a piece of content, or it may manage testing d test reporting of testing results related to content retention or comprehension. Such reporting may be by transmission of an external email, or by other data field output. And while the adjustment of the sub-content presented or displayed may be user selected, the interface shell may also be equipped with testing matrixes that provide integrated feedback to self-select for the repetition of content that has not been retained, or for adjustment of content sub-set to a form and presentation for better comprehension by the user.

The content generally comprises the coherent body of information to be related and may include text and audio and a body of interactive and multi-media elements including graphics, video and audio components. The body of interactive and multi-media elements may include interactive demonstrative components such as slider and scaler level adjustments to depict single or multiple factor modifications, such a temperature and/or pressure on an environment, or other means of relating content and engaging a user. The body of interactive and multi-media elements could be largely consistent across content subsets with alternate audio tracks as may be proper, or additional subsets of multi-media added to specific content sub-sets, while maintaining the principal content of interactive and multi-media elements as consistent across the content sub-sets for maintaining coherency and efficiency in production and presentation of content.

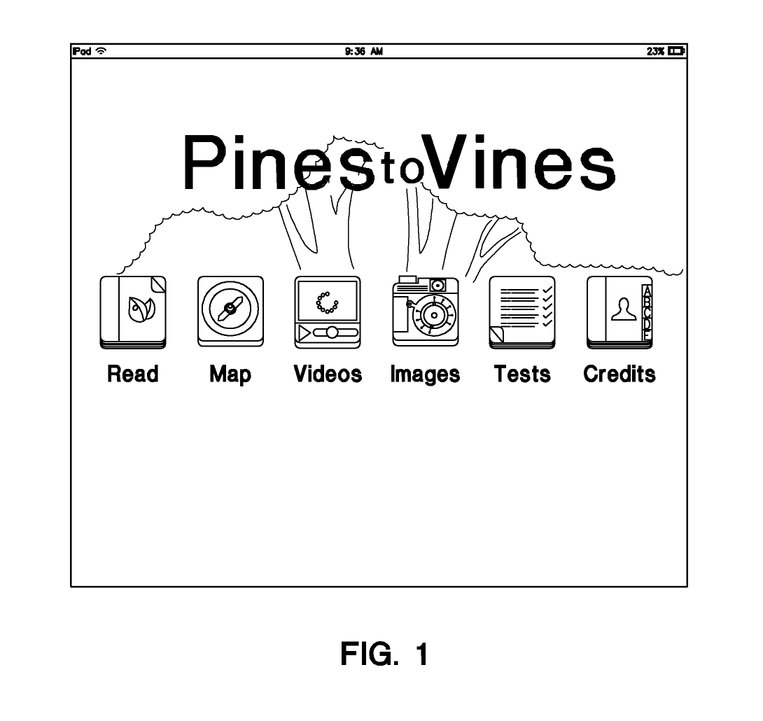

One body of content may related to physics, another may relate to marine biology and a third may relate to botany. A single content set, comprising any combination of text, video, graphics or other means of engaging a user may be presented with varying forms of information parsed for specific review, and may also include integrated testing material. A screen shot of one such presentation is depicted in FIG. 1.

Content is generally parsed to sub-sets with each subset comprising largely the same content presented in an alternate form to provide for multiple presentations simultaneously to several parties in a largely coherent manner. By selecting a specific sub-set, the user experiences content at the desired level of presentation, complexity, or language. The sub-sets are presented such that the majority of the information displayed on the display system through the interface shell is coherently presented across multiple sub-sets.

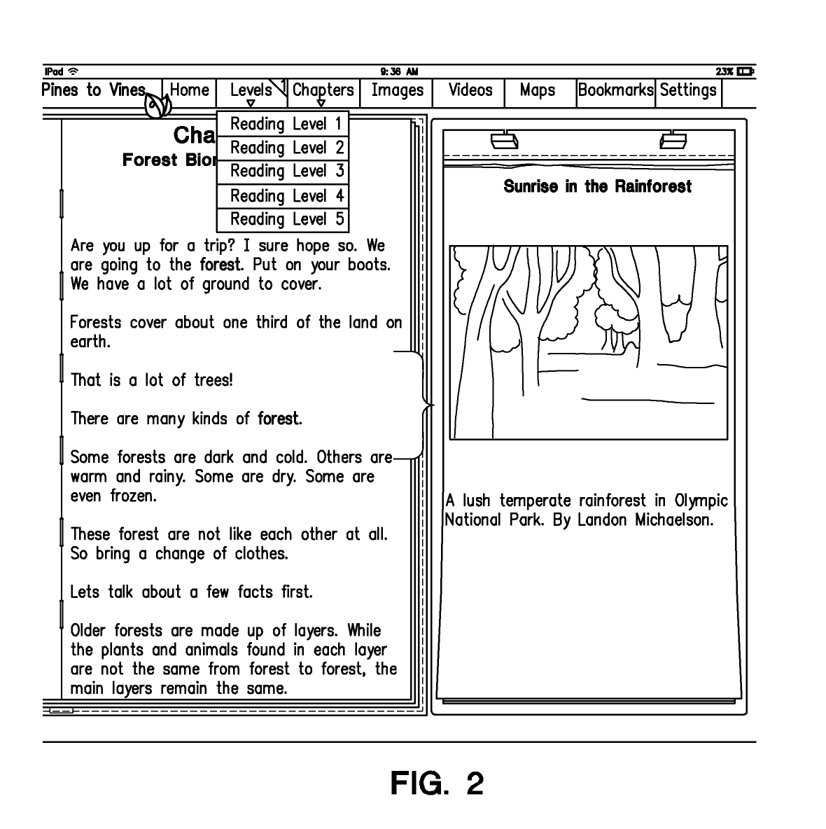

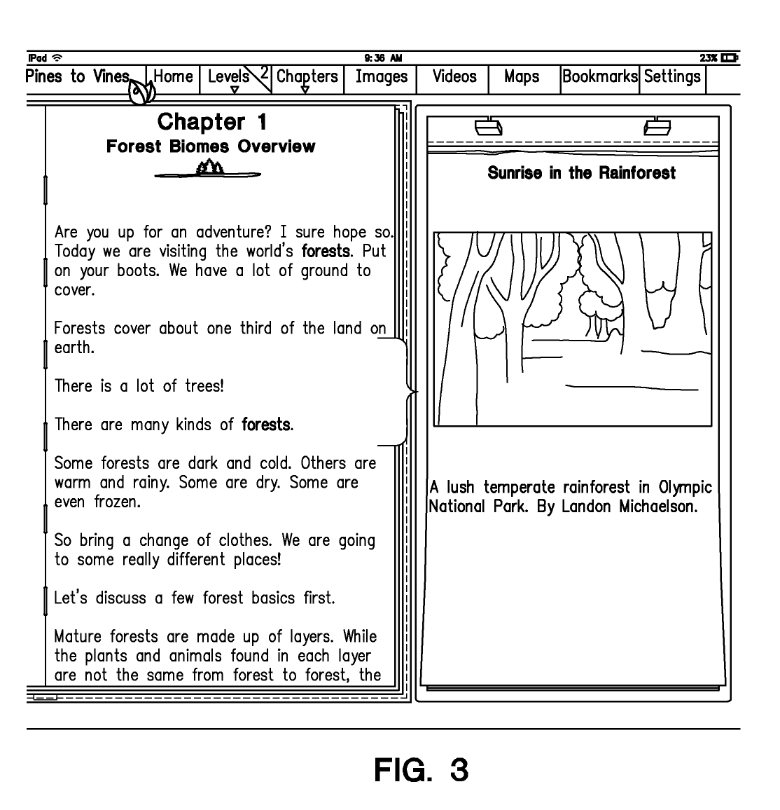

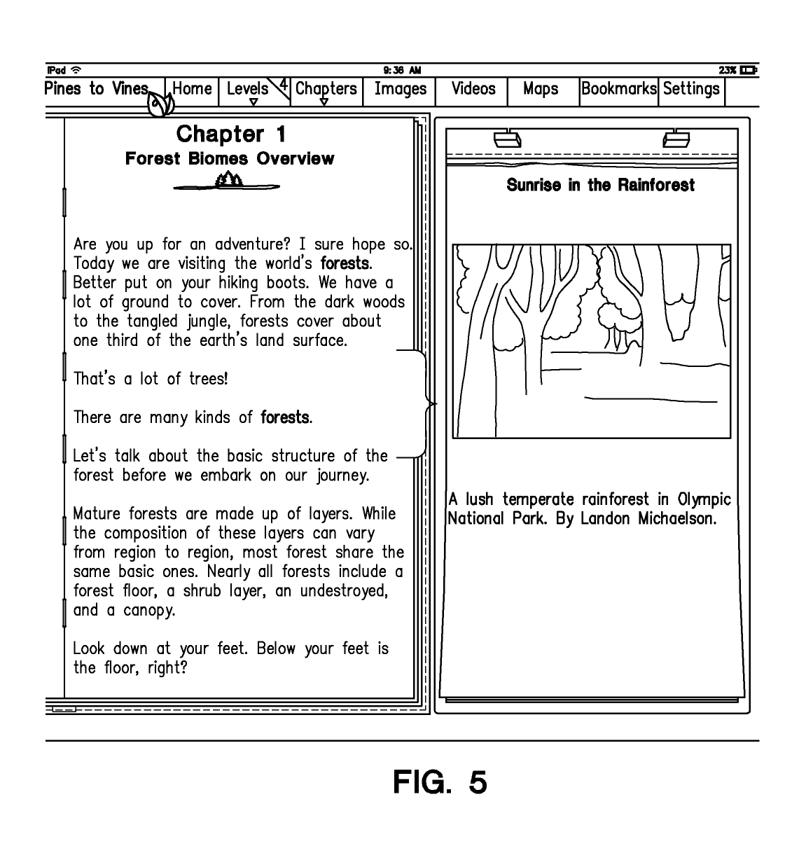

The user at any time may select which of the multiple sub-sets are being presented and alter the means of content presentation by increasing or degreasing the reading level, or even by changing the language. Efficiency may be obtained though consistent use of a largely singular set of graphics, animations or videos, with only those portions of the content that need to be adjusted being altered in the content sub-set shift. A depiction of a content sub-set presented at “Reading Level 1” is depicted in FIG. 2, with the presentation of a drop-down menu selector to permit a user to select alternate presentations. FIGS. 3 through 6 depict an exemplar of how varying content sub-sets may present the same coherent information with integrated graphics across varying reading levels. Each presentation being essentially the same information, presented in a manner tailored to the users desires or needs.

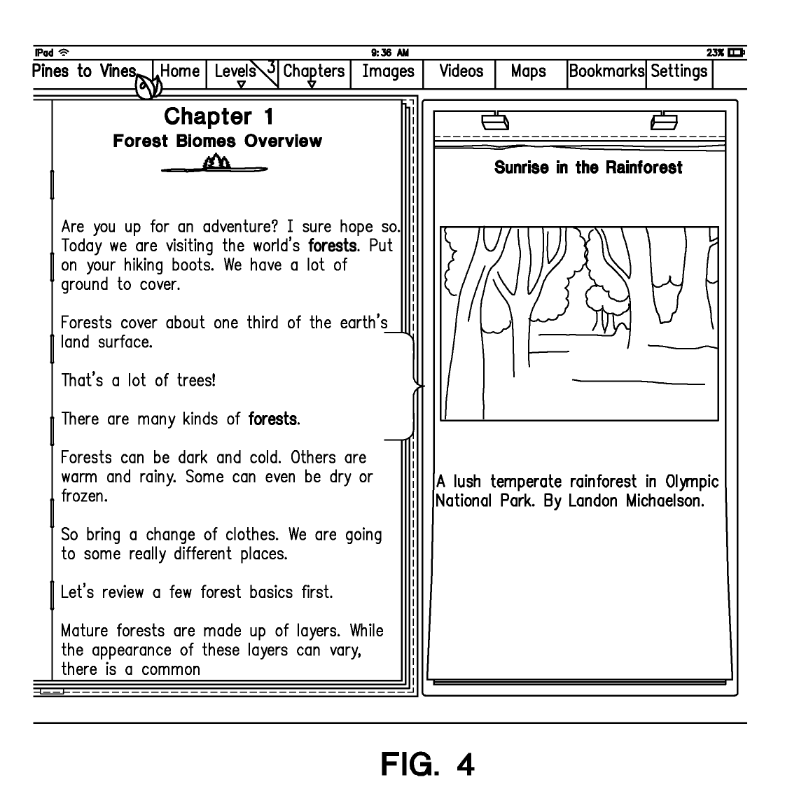

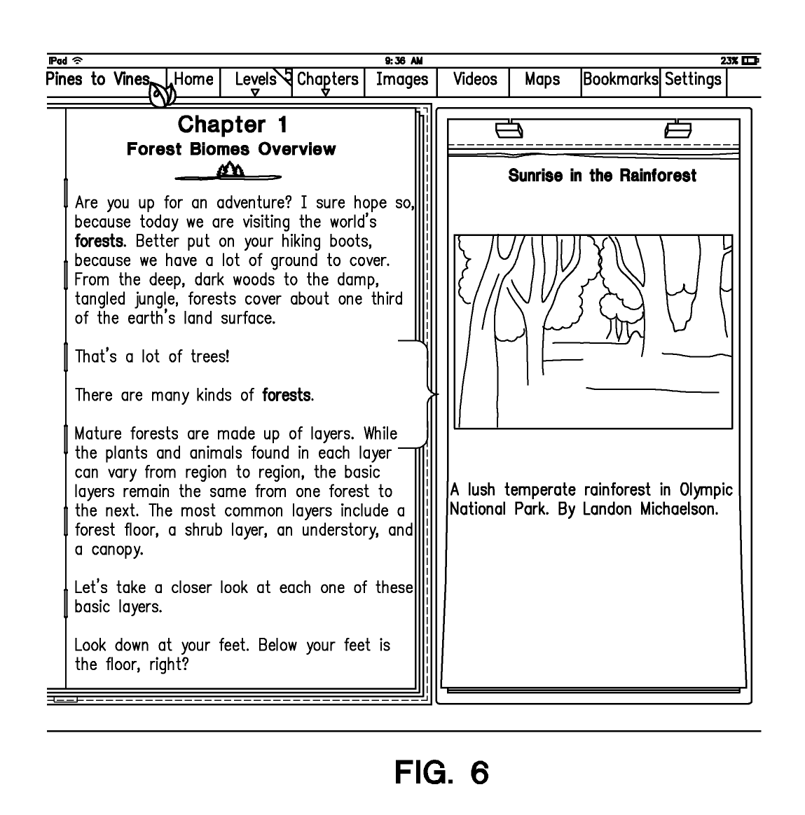

As an exemplar, for a lower level of reading the sub-set of content may relate, “Forests cover about one third of the land on earth.” FIG. 2. Should the reader be better engaged by a more advanced language, the same information is presented as, “Forests cover about one third of the earth's land surface.” FIG. 4. The more advanced content presenting the word “surface” which may not be in the vocabulary of some readers. The same information may also be presented with more context such as depicted in FIG. 6. The specific of the language used being secondary to the variety of manner of presentation allowed by multiple sub-sets. As shown, users are able to select among a variety of content sub-sets, yet each is presented with the same information maintain coherency of the information presented no matter the sub-set selected.

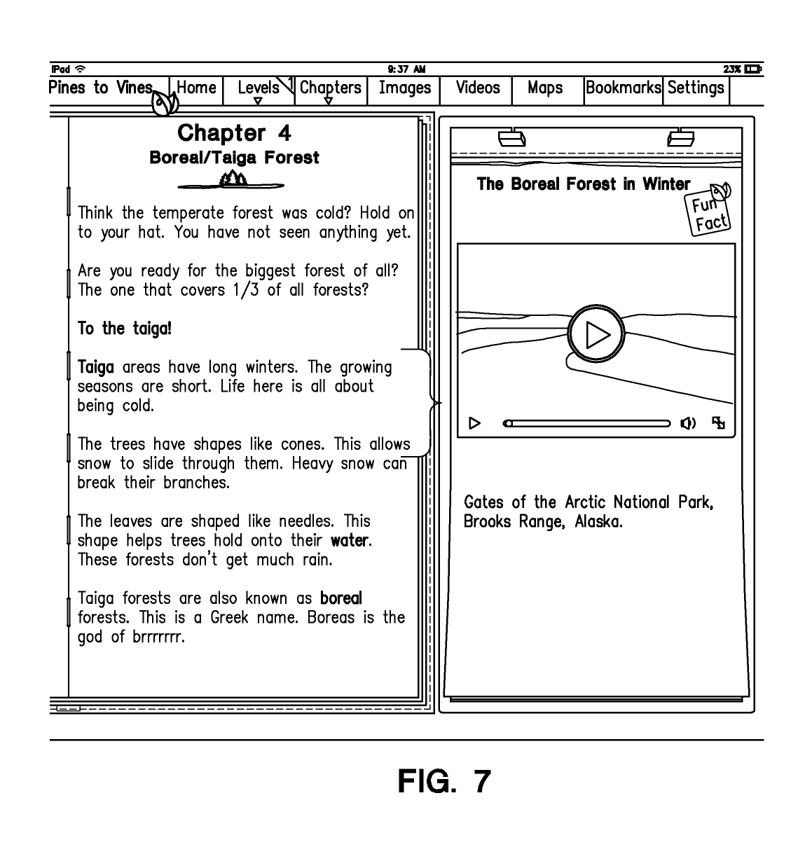

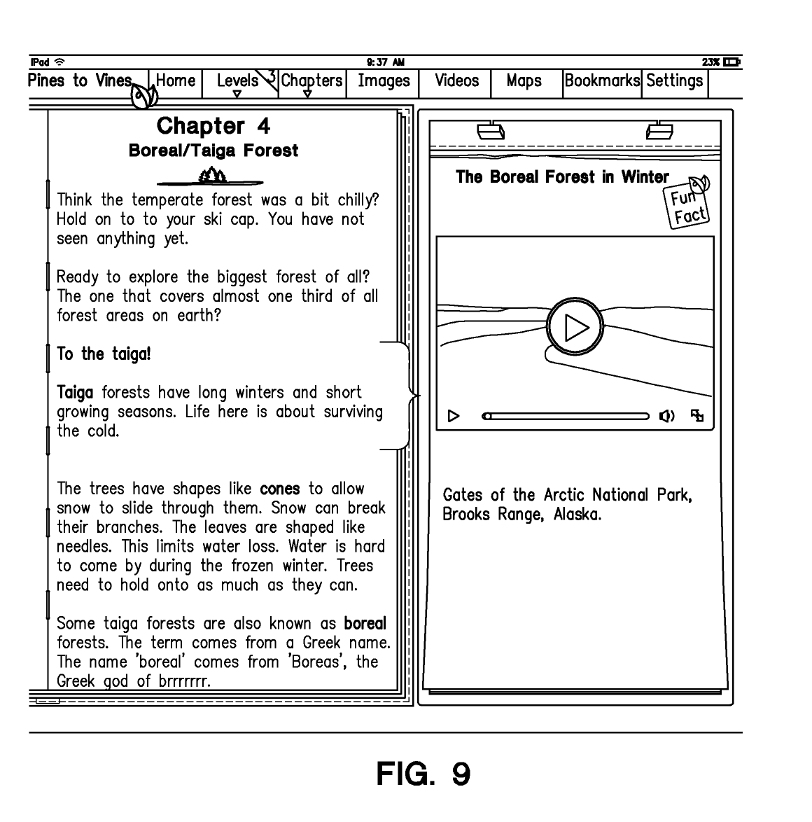

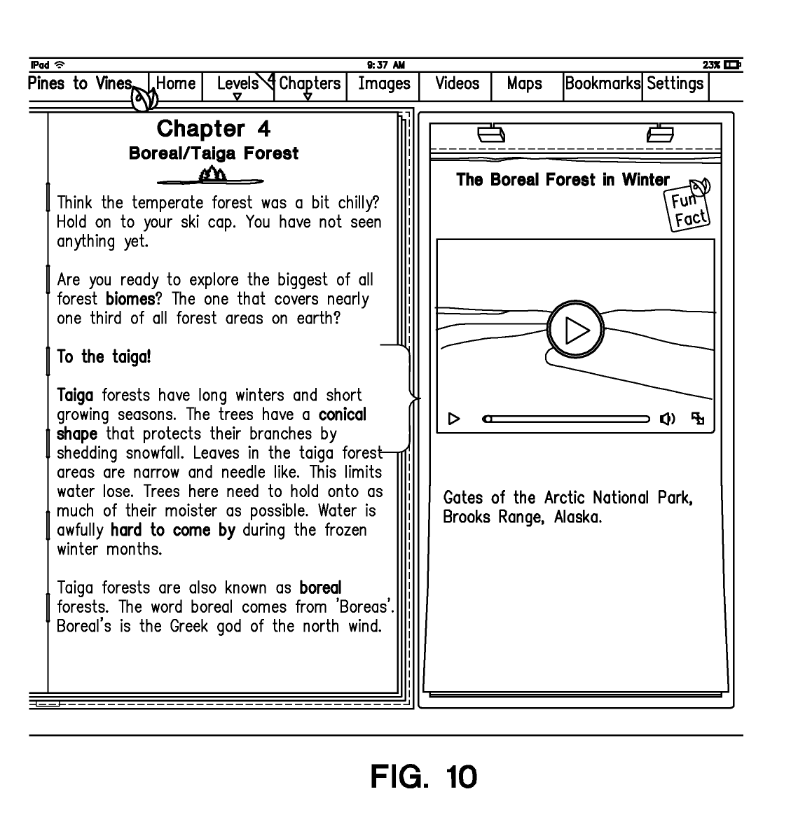

Similarly FIGS. 7 though 11 present yet another exemplar of how varying content subsets may present the same coherent information with integrated graphics across varying reading levels, each presenting with the same or similar expounding video content. As shown in FIG. 7, a portion of the content sub-set related information presented in a simple reading level states: “The trees have shapes like cones. This allows snow to slide through them. Heavy snow can break branches.” This same basic information is coherently related to a user of a higher reading level as, “The trees are shaped like cones to allow snow to slide through them. Snow can break their branches.” Presented in a more complex paragraph with other information. FIG. 9. At an even higher reading level, this same coherent information is presented in an alternate sub-set as, “Like temperate coniferous forests, the trees have a conical shape that protects their branches by shedding snowfall.” This time presented in an even more complex paragraph or context adaptable to more advanced readers. FIG. 10. As such, the same basic information is coherently presented, namely. The trees are shaped like cones, the shape allows them to shed snow which can break branches.

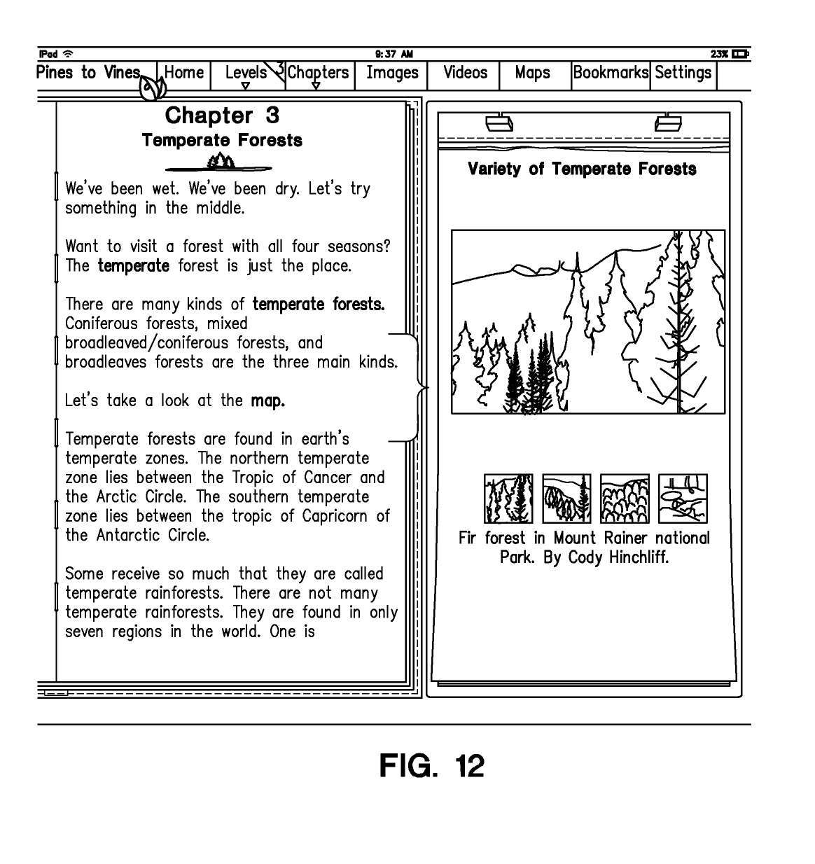

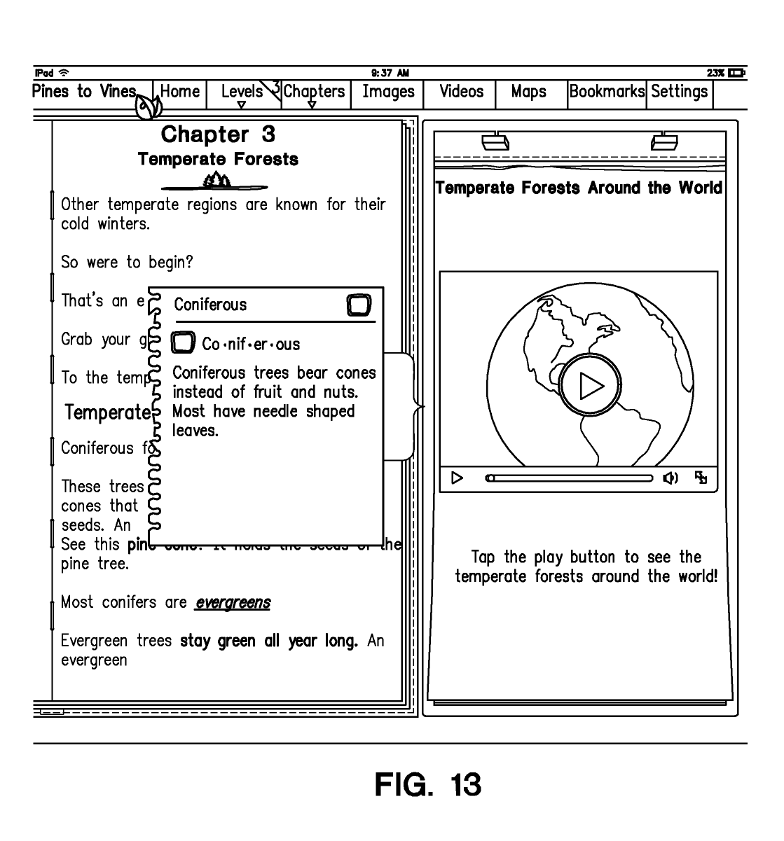

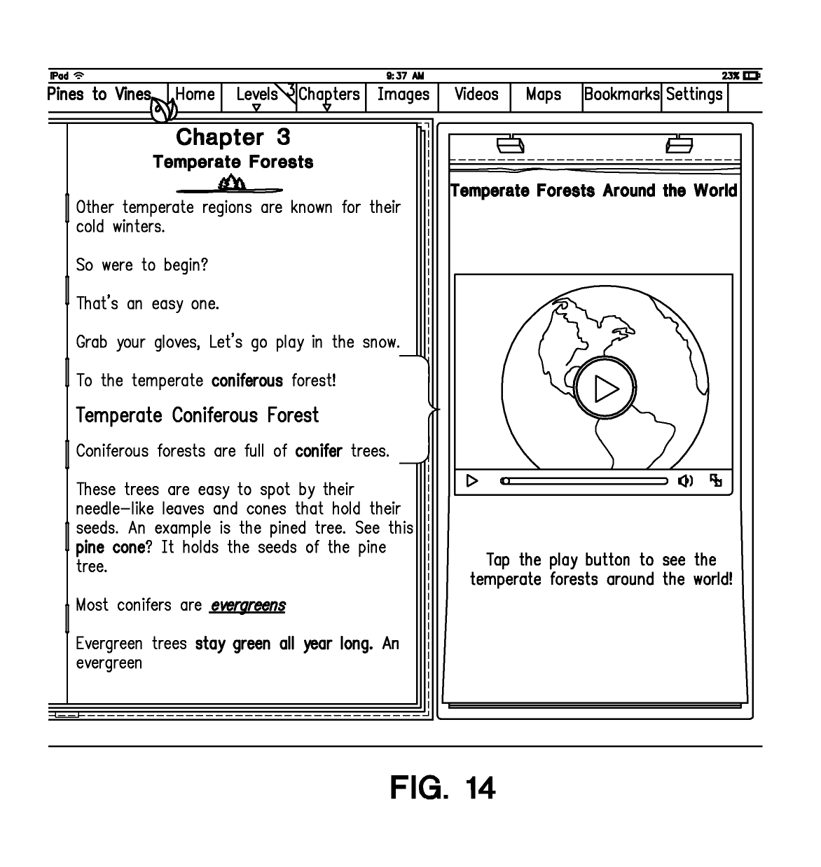

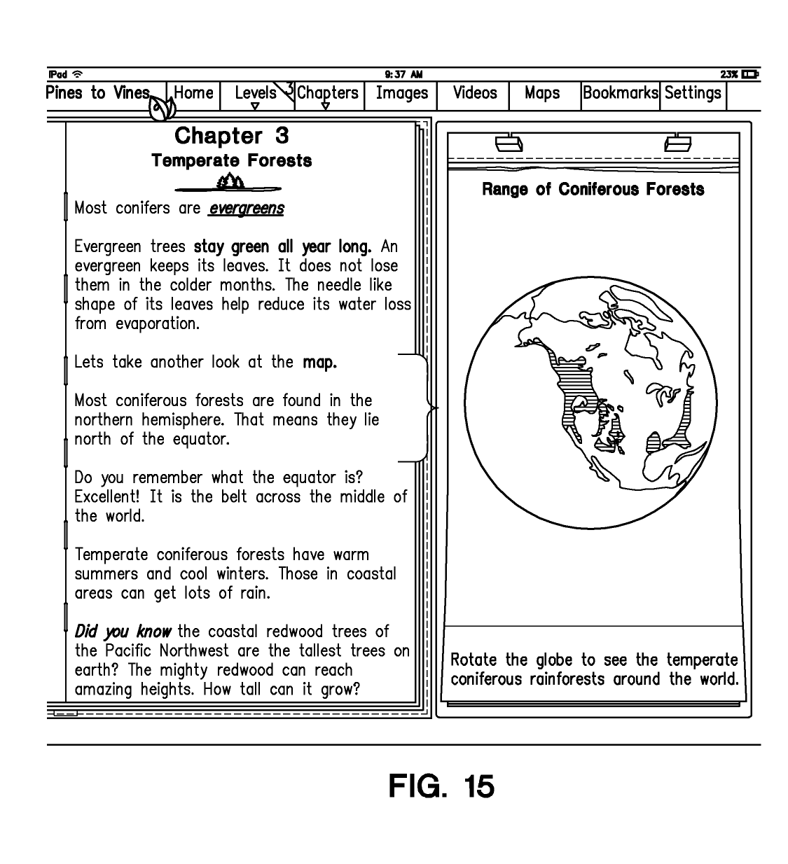

FIGS. 12 through 15 present how the underlying sub-sets of content may be unified with coherent maps, graphics and other material to permit a wide range of users to be presented with specific content sub-sets, yet all coherently experience similar data and experiences permitting a group of students or users to have a social experience with each receiving tailored presentations.

Similarly, it is disclosed that audio content may include a wide variety of representative sounds, such as the sounds of an environment, sound accompanying video, or sound effects that may relate to a physical event such as the popping of a balloon due to expanding gas in a thermodynamic reaction. As well, audio content may include an audio relation of the textual content sub-set of a book by chapter, paragraph, sentence or word such that on selection of an audio channel the user can select a chapter to be read in a language of choice, or may select only a paragraph, sentence, or even word when all that is needed is pronunciation. Audio channels may be presented in a language which is correlated to the language of the text or independent of the language of the text such that a user may read the text in one language, such as English, yet be presented with audio components in Spanish or another language.

The testing matrix is a means and system of evaluating the comprehension and retention of the content by the student. Testing matrixes may be integral and presented through the interface shell, or external though other means including traditional paper and pen.

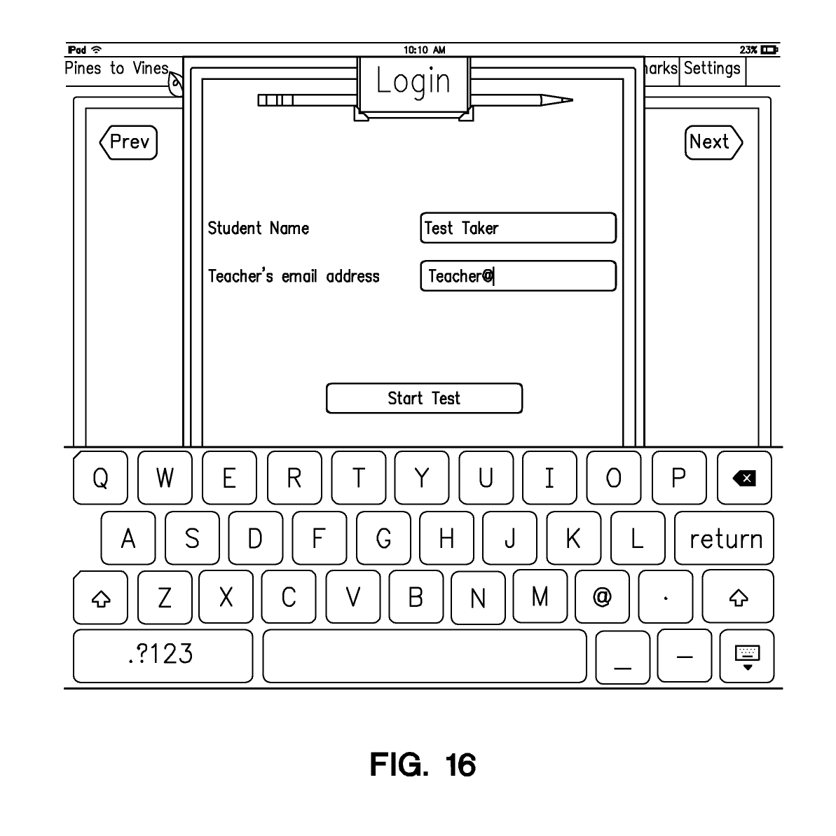

In the preferred embodiment the user will log in, which may be a simple as a manner depicted in FIG. 16, by providing an identifier such as their name. The interface shell will then present content related to testing, which may be similarly parsed to sub-sets based on the preferred or needed level or type of presentation for the user and collect their testing results. Such results may be stored in data storage or sent as output to be collecting by a third party or teacher such as by email.

Testing matrixes may include multiple factors. The most common and preferred would be retention or learning. Essentially reviewing and collecting the users retention of the content information. Data output, related to a third party may be used for evaluation or direction for review of content a second or third time. Similarly, the testing matrix may direct the user directly to further review of content for which there is insufficient retention.

Testing matrixes may also be set for comprehension, namely testing to ascertain whether the content sub-set presented is level appropriate for the user and whether or not content should be re-presented at an alternate level or in an alternate language, or whether the content sub-set level or language is sufficient for continued use at the set level.

The data output system is a method of collecting and presenting available data related to a students use of the display system either by saving data to the internal storage of the display system for later retrieval or by transmission to an external system. Such data may include time spent by the student on any particular point of content, such as might indicate reading speed, interest, or comprehension. Such data might also include the result of integral testing at periodic intervals and may also include other feedback systems installed throughout the content.

Exemplar of Use

In operation of the preferred embodiment, content comprising multiple content sets is loaded onto a display system such as an Apple iPad™ and run. On initial use the user may input their general information, such as name and output for testing and data sets collected, or this may be entered at a later testing point. The user then selects a content sub-set targeted to their reading level or preferences. FIG. 2. The content sub-set is then presented to the user who proceeds to progress through the content in a usual fashion.

In viewing the content sub-set the user is able to engage the various interactive and multimedia aspects of the content sub-set which are largely the same across the various content sub-sets. The presentation is such that in a chapter-by-chapter or section-by-section comparison the content is coherent from content sub-set to content sub-set. FIGS. 2 The coherency based on chapter or section permits students who might be side by side to review the same basic information, yet each have the information targeted to their reading level or language preference. This coherency also permits the students to interact based on the content present and to uniformly engage the teacher with the same basic content.

Periodically testing is presented to students. If students have not yet input their identification data, they a then do so such that testing data results are recorded such as on internal memory of the display system for later retrieval or for transmission such as by email to a teacher or other grader through a data output system.

Testing which evaluates retention may direct a user to review prior material. Testing which evaluates comprehension may direct the user to an alternate content sub-set such as an easier or more difficult reading level, or an alternate language.

Should the user be directed to or wish to alter the content sub-set, this is done at any point, reverting the user to another content sub-set with the same coherent information, simply presented in an alternate form.

It is in this manner that the invention is capable of presenting a coherent body of information in varying forms to a wide array of users or students, who each are able to receive the same basic information tailored to their reading level or language. In this manner the social aspects of uniform learning are preserved as students are able to uniformly interact with the teacher and each other. Similarly, a single teacher is able to effectively instruct a larger body of students with varying capabilities in a uniform body of information leading to more efficient and effecting instruction.

Accordingly, while only a single embodiment of the present invention with derivatives has been shown and described, it is obvious that many changes and modifications may be made thereunto without departing from the spirit and scope of the invention, which is defined by the claims presented.

I Claim:

1. An e-book comprising:
a display system, an interface shell, content comprising multiple interchangeable content sub-sets wherein at least two or more of the interchangeable content sub-sets contain essentially the same uniform information with differing textual component presentations, and a method of selecting between interchangeable content sub-sets and displaying on the display system one of said selected interchangeable content sub-sets, wherein said content is presented through said interface shell on said display system.

2. The e-book of claim 1 further comprising an integrated testing means for determining content retention.

3. The e-book of claim 1 further comprising an integrated testing means for determining content comprehension.

4. The e-book of claim 1 further comprising the means of switching between said interchangeable content sub-sets and maintaining coherency at any point of switching.

5. The e-book of claim 1 wherein said content sub-sets are integrated with a singular body of interactive and multi-media elements to uniformly present said body of interactive and multi-media elements with each of said content sub-sets.

6. The e-book of claim 1 wherein at least one of said content sub-sets is comprised of an audio component that presents said textual component in an audio format.

7. The e-book of claim 6 wherein said audio component is of a language that differs from the language of said textual component.

8. The e-book of claim 6 wherein said audio component to be presented may be isolated to a chapter, paragraph, sentence or word.

9. A method of displaying content through an interface shell on a display system comprising selecting among a number of content sub-sets, wherein each of said content sub-sets comprises essentially the same coherent uniform information with differing presentations, and displaying said selected content sub-set on said display system.

10. The method of claim 9 further comprising the steps of presenting a testing matrix through said interface shell on said display system, and testing for content retention and recording the results of said testing for content retention.

11. The method of claim 9 further comprising the steps of presenting a testing matrix through said interface shell on said display system, and testing for content comprehension and recording the results of said testing for content comprehension.

12. The method of claim 9 further comprising providing a switching means for switching between said interchangeable content sub-sets and maintaining coherency at any point of switching.

13. The method of claim 9 further comprising providing an integrated singular body of interactive and multi-media elements and uniformly presenting said body of interactive and multi-media elements with each of said content sub-sets.

14. The method of claim 9 further comprising providing an audio component that presents said textual component in an audio format.

15. A method of displaying content through an interface shell on a display system comprising selecting among a number of content sub-sets, wherein each of said content sub-sets comprises essentially the same coherent information with differing presentations, and displaying said selected content sub-set on said display system and providing a switching means to permit switching between said interchangeable content sub-sets and maintaining coherency across the several content sub-sets at any point of switching.

16. The method of claim 15 further comprising the step of testing for determining content retention.

17. The method of claim 15 further comprising the step of testing for determining content comprehension.
